(19) United States
(12) Patent Application Publication
(10) Pub. No.: US 2009/0222758 A1
(43) Pub. Date: Sep. 3, 2009

(54) CONTENT REPRODUCTION APPARATUS AND METHOD

(75) Inventors: Deok-Won KIM, Incheon (KR); Young-Kyu JIN, Seoul (KR); Seung-Eok CHOI, Suwon-si (KR); Hyun-Joo KANG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/351,888

(22) Filed: Jan. 12, 2009

(30) Foreign Application Priority Data
Feb. 28, 2008 (KR) 10-2008-0018444

(51) Int. Cl. H04N 5/91; G06F 3/048

(52) U.S. Cl. 715/779; 386/46

(57) ABSTRACT

A content reproduction apparatus and method are provided. The content reproduction apparatus includes a creation module which creates a log information list including log information regarding one or more valid portions selected from an original content; and a reproduction module which reproduces an unoriginal content with reference to the log information list, the unoriginal content being a combination of the one or more selected valid portions of the original content.

### CROSS-REFERENCE TO RELATED APPLICATION

This application claims priority from Korean Patent Application No. 10-2008-0018444 filed on Feb. 28, 2008 in the Korean Intellectual Property Office, the disclosure of which is incorporated herein by reference in its entirety.

### BACKGROUND OF THE INVENTION

1. Field of the Invention

Apparatuses and methods consistent with the present invention relate to content reproduction, and more particularly, to content reproduction in which contents can be easily processed according to user preferences.

2. Description of the Related Art

Digital devices typically include circuits capable of processing digital data. Examples of the digital devices include non-portable digital devices such as digital televisions (TVs) and Internet Protocol TVs (IPTVs) and portable digital devices such as mobile phones and portable multimedia players (PMPs). Digital devices can be connected to the Internet in either a wired or wireless manner. Thus, digital devices can be provided with various contents by a content provider through the Internet to reproduce the contents.

However, related art digital devices are only capable of reproducing contents provided by a content provider and cannot allow users to process contents according to their preferences.

Therefore, it is desirable to develop a technology capable of easily processing contents according to user preferences and reproducing the processed contents.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. Accordingly, aspects of the present invention provide a content reproduction apparatus and method, in which contents are processed according to user preferences prior to being reproduced.

According to an aspect of the present invention, there is provided a content reproduction apparatus including: a creation module which creates a log information list including log information regarding one or more valid portions selected from at least one original content; and a reproduction module which reproduces an unoriginal content with reference to the log information list, the unoriginal content being a combination of the valid portions of the original content.

According to another aspect of the present invention, there is provided a content reproduction method including: creating a log information list including log information regarding one or more valid portions selected from at least one original content; and reproducing an unoriginal content with reference to the log information list, the unoriginal content being a combination of the valid portions of the original content.

### BRIEF DESCRIPTION OF THE DRAWINGS

The above and other aspects and features of the present invention will become more apparent by describing in detail exemplary embodiments thereof with reference to the attached drawings, in which:

FIG. 1 illustrates a schematic diagram of a content reproduction system according to an exemplary embodiment of the present invention;

FIG. 2 illustrates a block diagram of a content reproduction apparatus according to an exemplary embodiment of the present invention;

FIG. 3 illustrates a diagram of a graphic user interface (GUI) for selecting one or more valid portions, according to an exemplary embodiment of the present invention;

FIG. 4 illustrates a diagram of a log information list according to an exemplary embodiment of the present invention;

FIG. 5 illustrates a diagram of a GUI for setting detailed information regarding each valid portion, according to an exemplary embodiment of the present invention;

FIG. 6 illustrates a diagram of a GUI for associating a valid portion with another valid portion, according to an exemplary embodiment of the present invention;

FIG. 7 illustrates a table of an example of the log information list illustrated in FIG. 4;

FIG. 8 illustrates a diagram of a GUI for providing summary information of each valid portion, according to an exemplary embodiment of the present invention;

FIG. 9 illustrates a diagram of a GUI for providing guide information regarding valid portions during the reproduction of an unoriginal content, according to an exemplary embodiment of the present invention; and

FIG. 10 illustrates a flowchart of a content reproduction method according to an exemplary embodiment of the present invention.

### DETAILED DESCRIPTION OF THE EXEMPLARY EMBODIMENTS

The various aspects and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the present invention to those skilled in the art, and the present invention is defined by the appended claims. Like reference numerals refer to like elements throughout the specification.

The exemplary embodiments of the present invention are described hereinafter with reference to block diagrams or flowcharts for illustrating content reproduction apparatuses and methods.

It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

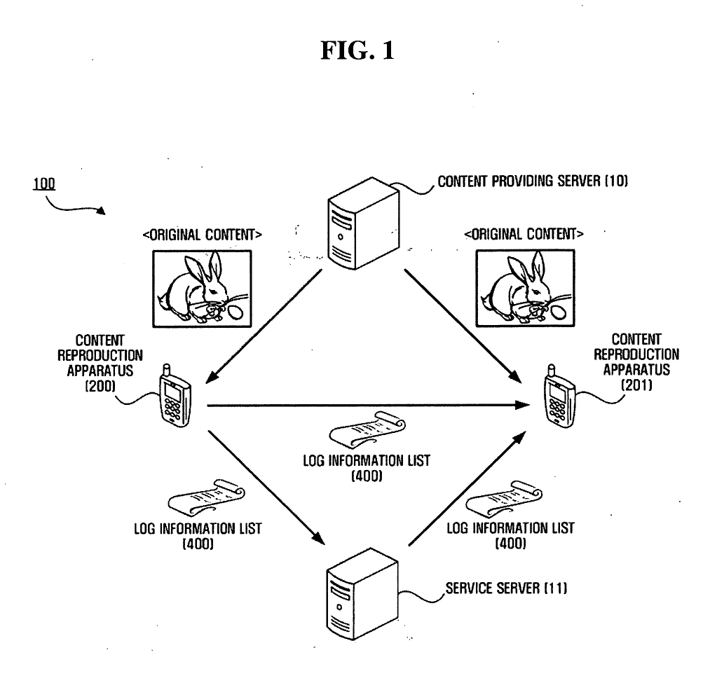

FIG. 1 illustrates a schematic diagram of a content reproduction system 100 according to an exemplary embodiment of the present invention. Referring to FIG. 1, the content reproduction system 100 includes a content providing server 10, content reproduction apparatuses 200 and 201, and a service server 11.

The content providing server 10 may provide multimedia contents to the content reproduction apparatuses 200 and 201 through, for example, the Internet. Multimedia contents are digital objects including at least one of video, audio and text data. Examples of multimedia contents include moving images, still images, music files, Java games, electronic books, and various digital broadcasting data such as digital multimedia broadcasting (DMB) data, digital video broadcasting (DVB) data, or digital audio broadcasting (DAB) data.

The content reproduction apparatus 200 may reproduce an original content. That is, the reproduction of the original content may be interpreted as displaying the original content visually and/or audibly so that the original content can be readily used by a user of the content reproduction apparatus 200. The content reproduction apparatus 200 may either play or display the original content. More specifically, if the original content is moving image data or a music file, the content reproduction apparatus 200 may play the original content. On the other hand, if the original content is a still image, the content reproduction apparatus 200 may display the original content with the use of a display device.

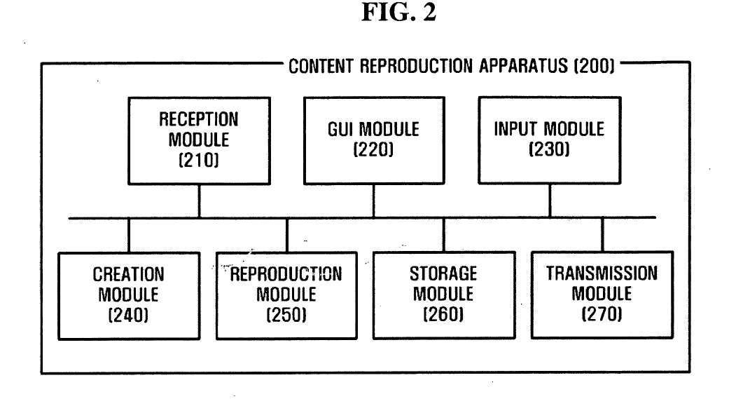

The content reproduction apparatus 200 may create an unoriginal content. The unoriginal content is a multimedia content obtained by combining one or more valid portions selected from one or more original contents. The unoriginal content may be reproduced with reference to a log information list 400 including information regarding the valid portions used to create the unoriginal content. The content reproduction apparatus 200 may transmit the log information list 400 to the service server 11 so that the log information list 400 can be shared with the content reproduction apparatus 201. Alternatively, the content reproduction apparatus 200 may transmit the log information list 400 directly to the content reproduction apparatus 201. The structure and the operation of the content reproduction apparatus 200 will be described later in further detail with reference to FIGS. 2 through 9.

The service server 11 may store and manage the log information list 400. More specifically, if the content reproduction apparatus 201 requests the log information list 400, the service server 11 may search for the log information list 400 and provide the log information list 400 to the content reproduction apparatus 201. For this, the service server 11 may provide a GUI for searching the service server 11 for the log information list 400. The service server 11 and the content providing server 10 may be incorporated into a single device or may be provided as separate devices.

The structure and the operation of the content reproduction apparatus 200 illustrated in FIG. 1 will hereinafter be described in further detail with reference to FIGS. 2 through 9.

FIG. 2 illustrates a block diagram of the content reproduction apparatus 200. Referring to FIG. 2, the content reproduction apparatus 200 includes a reception module 210, a GUI module 220, an input module 230, a creation module 240, a reproduction module 250, a transmission module 270 and a storage module 260.

The reception module 210 may receive an original content and recommendation information regarding the original content. The recommendation information may include selection frequency information indicating a number of times each portion of the original content has been selected and a recommended title for each portion of the original content. More specifically, if the original content is moving image data, the selection frequency information may be interpreted as representing a number of times each frame or section of the moving image data has been selected. On the other hand, if the original content is a still image, the selection frequency information may be interpreted as a number of times each area in the still image has been selected. The selection frequency information may be determined by analyzing how often each portion of the original item has been selected by the users of other content reproduction apparatuses. The recommended title for each portion of the original content may be determined by analyzing how the users of other content reproduction apparatuses have titled each portion of the original content. For example, a title most recommended for a portion of the original content by the users of other content reproduction apparatuses may be used as a recommended title for the corresponding portion of the original content. The service server 11 or the content providing server 10 may analyze a number of times each portion of the original content has been selected by the users of other content reproduction apparatuses and how the users of other content reproduction apparatuses have titled each portion of the original content.

The input module 230 may receive a reproduction command to reproduce the original content and a valid portion selection command to select one or more valid portions from the original content. If the original content is moving image data, the valid portion selection command may be classified into a scene selection command or a section selection command. The section selection command may include a section start selection command and a section end selection command.

In order to receive various commands from a user of the content reproduction apparatus 200, the input module 230 may include one or more input keys for generating a key signal. For example, the input module 230 may include a reproduction key for reproducing the original content, a scene selection key for selecting one or more scenes from the original content, and a section selection key for selecting a section of the original content. The scene selection key and the section selection key may be provided as separate keys or may be incorporated into a single key.

If the scene selection key and the section selection key are incorporated into a single selection key, the selection key may be manipulated in different manners so as to input various commands. For example, the selection key may be pressed in different manners so as to input a scene selection command and a section selection command. More specifically, a scene selection command may be input by pressing the selection key for less than a predefined amount of time, and a section start selection command and/or a section end selection command may be input by pressing the selection key for more than the predefined amount of time. Alternatively, a scene selection command may be input by pressing the selection key once, and a section start selection command and/or a section end selection command may be input by pressing twice in a row. The input keys of the input module 230 may be realized as hardware keys or as software keys such as icons.

The GUI module 220 may provide the user of the content reproduction apparatus 200 with various GUIs, for example, a GUI for selecting one or more valid portions from the original content, a GUI for setting detailed information for each of the valid portions, and a GUI for providing summary information of each of the valid portions.

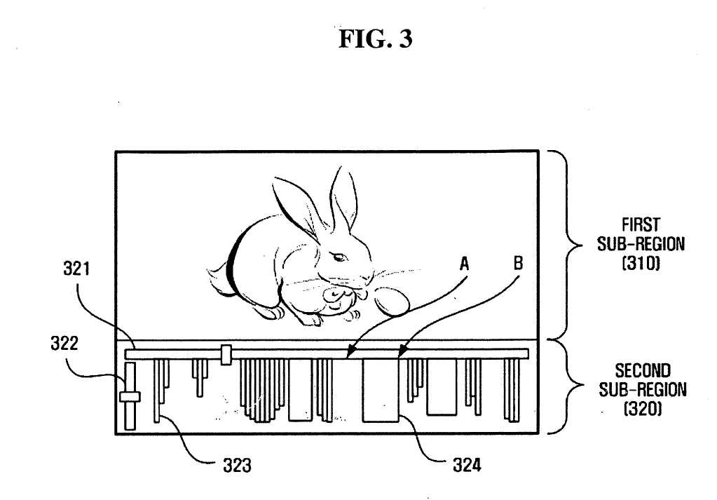

FIG. 3 illustrates a diagram of a GUI for selecting one or more valid portions from an original content, according to an exemplary embodiment of the present invention. Referring to FIG. 3, the GUI may include a first sub-region 310 and a second sub-region 320. An original content may be displayed in the first sub-region 310. A progress bar 321 and a plurality of bars 323 and 324 may be displayed in the second sub-region 320. The progress bar 321 indicates the state of the reproduction of the original content, and the bars 323 and 324 indicate a number of times each valid portion of the original content has been selected. A threshold setting bar 322 may also be displayed in the second sub-region 320. The threshold setting bar 322 allows the user of the content reproduction apparatus 200 to set a selection frequency threshold for automatically selecting one or more valid portions from the original content according to a number of times each of the valid portions has been selected. The bars 323 and 324 may form a bar graph by being arranged along a horizontal axis of the second sub-region 320. The threshold setting bar 322 may be displayed along a vertical axis of the second sub-region 320.

The creation module 240 creates a log information list 400 including log information regarding each valid portion selected from the original content. More specifically, if the user of the content reproduction apparatus 200 inputs a scene selection command or a section selection command with the use of the input module 230 during the reproduction of the original content, the creation module 240 may store log information regarding each valid portion selected by the user of the content reproduction apparatus 200 in the log information list 400.

If the selection frequency threshold has already been set through the GUI illustrated in FIG. 3, the creation module 240 may automatically store one or more valid portions of the original content having a frequency of selection higher than the selection frequency threshold in the log information list 400.

If a section start selection command and a section end selection command are input by the user of the content reproduction apparatus 200, the creation module 240 may store log information regarding a section selected from the original content according to the section start selection command and the section end selection command. The creation module 240 may also automatically store log information regarding a section of the original content even when no section end selection command is input by the user of the content reproduction apparatus 200. More specifically, referring to FIG. 3, if a section start selection command is input by the user of the content reproduction apparatus 200 when point A is encountered and no section end point command is input until point B, which is the end point of the closest recommended section 324 to point A, is encountered, the creation module 240 may designate point B as the end point of a section start from point A and store log information regarding point B in the log information list 400.

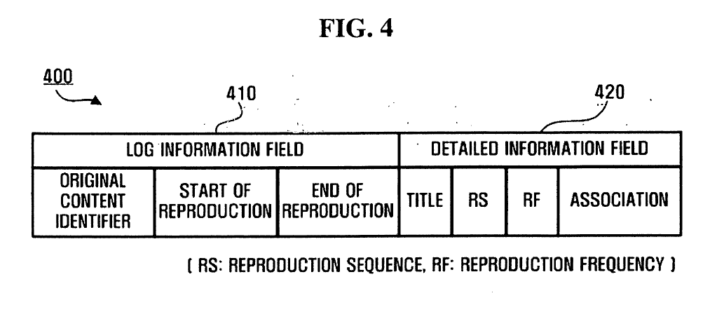

The log information list 400 will hereinafter be described in further detail with reference to FIG. 4.

FIG. 4 illustrates a diagram of the log information list 400. Referring to FIG. 4, the log information list 400 may include a log information field 410 and a detailed information field 420.

The log information field 410 may contain log information of a valid portion of an original content. Examples of the log information include an identifier of the original content and reproduction start information indicating when the reproduction of the valid portion will begin and reproduction end information indicating when the reproduction of the valid portion will end. The log information may be stored when the valid portion is selected from the original content in response to a valid portion selection command.

The detailed information field 420 may contain detailed information of the valid portion. Examples of the detailed information include the title of the valid portion, reproduction sequence information indicating when to reproduce the valid portion, reproduction frequency information indicating a number of times the valid portion has been reproduced, and association information indicating whether the valid portion is associated with other valid portions.

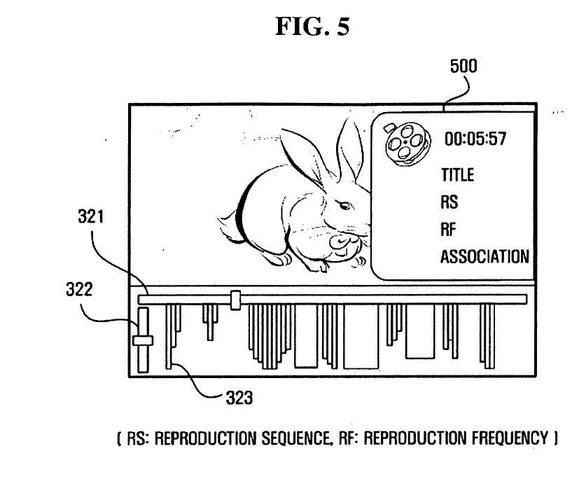

Detailed information regarding each valid portion of an original content may be stored when a corresponding valid portion is selected from the original content. More specifically, when a valid portion is selected from the original content, a GUI 500 for setting detailed information for the selected valid portion may be provided, as illustrated in FIG. 5. The GUI 500 may display a recommended title for the selected valid portion as a default title. Then, the user of the content reproduction apparatus 200 may use the default title as is or may input a new title for the selected valid portion.

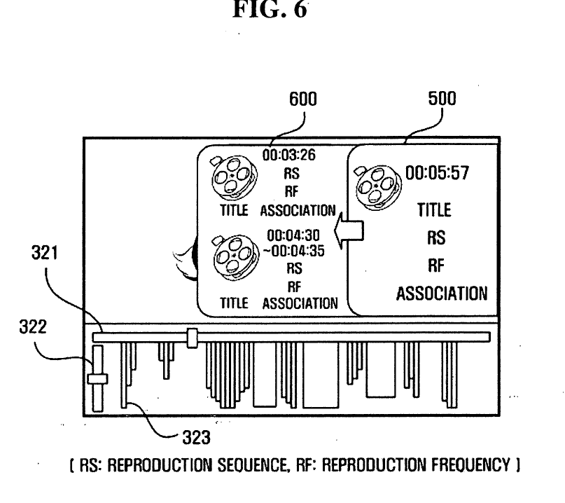

In order to associate a new valid portion with one or more existing valid portions, a GUI 600 may be provided, as illustrated in FIG. 6. The GUI 600 provides detailed information regarding one or more existing valid portions. Then, the user of the content reproduction apparatus 200 may select one of the existing valid portions and associate the new valid portion with the selected existing valid portion.

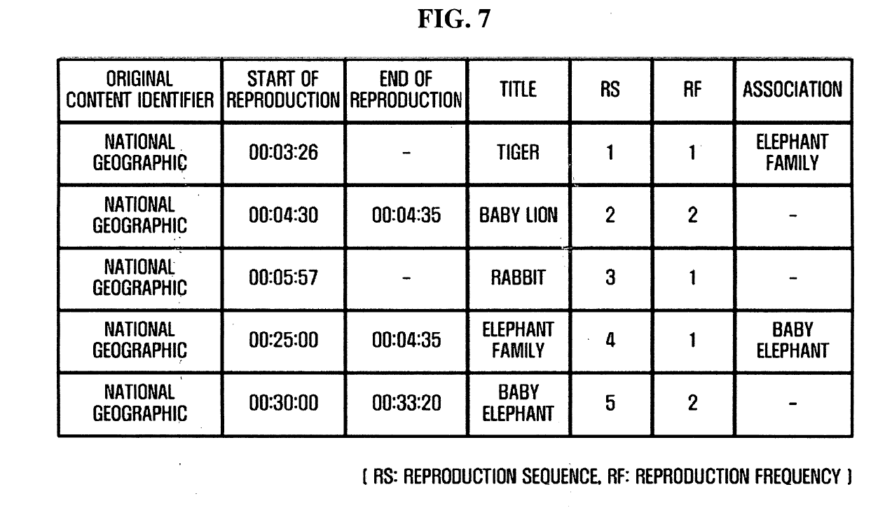

Alternatively, detailed information regarding each valid portion of an original content may be stored when the selection of one or more valid portions from the original content is complete. More specifically, if the selection of one or more valid portions from the original content is complete, a GUI for setting detailed information may be provided. That is, a log information list 400 having a log information field 410 filled with various log information and an empty detailed information field 420 may be provided. Then, the user of the content reproduction apparatus 200 may fill the empty detailed information field 420 of the log information list 400 with various detailed information, as illustrated in FIG. 7. The GUI for setting detailed information may display a valid portion selected manually by the user of the content playback apparatus 200 differently from a valid portion selected automatically according to a set of rules. For example, if a valid portion entitled ‘Tiger’ is selected manually by the user of the content reproduction apparatus 200, the valid portion entitled ‘Tiger’ may be displayed differently from other valid portions in terms of, for example, a font color, a font style, and a font type.

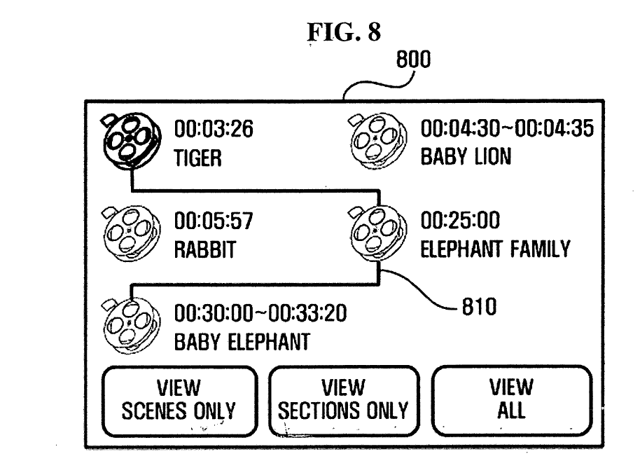

Likewise, summary information of a valid portion selected manually by a user may be displayed differently from summary information of a valid portion selected automatically according to a set of rules set by the user. FIG. 8 illustrates a GUI 800 including summary information of each valid portion. Referring to FIG. 8, summary information of a valid portion may include a thumbnail image of the valid portion, reproduction start information indicating when the reproduction of the valid portion will begin, reproduction end information indicating when the reproduction of the valid portion will end, the title of the valid portion, and association information of the valid portion. A thumbnail image of a valid portion selected manually by a user may be rendered with bold solid lines, whereas a thumbnail image of a valid portion selected automatically according to a set of rules may be rendered with thin solid lines. Thumbnail images of valid portions that are associated with each other may be connected by a connection line 810. However, if no association information is set in the log information list illustrated in FIG. 7, the connection line may not be displayed.

Referring to FIG. 2, the reproduction module 250 may reproduce an unoriginal content, which is the combination of one or more valid portions selected from an original content, with reference to a log information list 400. The reproduction module 250 may create and reproduce various unoriginal contents based on a single original content according to user preferences.

More specifically, if a plurality of valid portions selected from an original content are all selected to be reproduced, the reproduction module 250 may sequentially reproduce all the valid portions. For example, referring to FIG. 8, a GUI 800 displays a plurality of valid portions selected from an original content. If an icon ‘View All’ is selected from the GUI 800, the reproduction module 250 may sequentially reproduce all the valid portions displayed in the GUI 800 according to predefined settings.

On the other hand, if only one of the valid portions of the original content is selected to be reproduced, the reproduction module 250 may determine whether the selected valid portion is associated with any one of the other valid portions of the original content.

If the selected valid portion is not associated with any one of the other valid portions, the reproduction module 250 may reproduce only the selected valid portion. For example, referring to the GUI 800 illustrated in FIG. 8, if the selected valid portion is a valid portion entitled ‘Baby Lion’, the reproduction module 250 may reproduce only the valid portion entitled ‘Baby Lion’.

On the other hand, if the selected valid portion is associated with any one of the other valid portions, the reproduction module 250 may sequentially reproduce the selected valid portion and the valid portion(s) associated with the selected valid portion. For example, referring to FIG. 8, if the selected valid portion is a valid portion entitled ‘Elephant Family’, the reproduction module 250 may sequentially reproduce a valid portion entitled ‘Tiger’, the valid portion ‘Elephant Family’, and a valid portion entitled ‘Baby Elephant’.

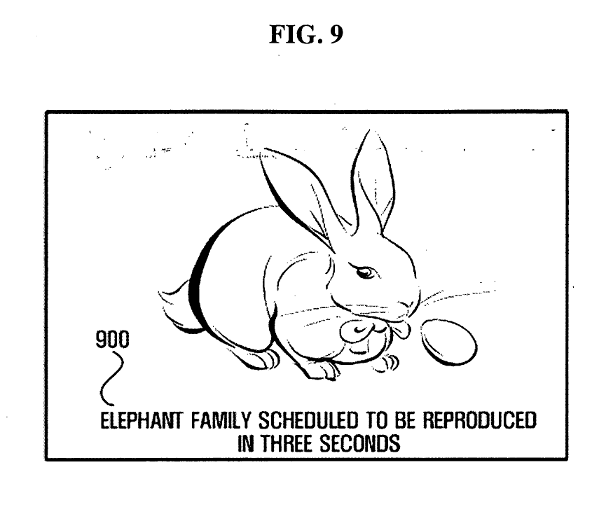

Referring to FIG. 9, the reproduction module 250 may display guide information 900 while sequentially reproducing one or more valid portions selected to be reproduced. The guide information 900 indicates a valid portion to be displayed next. For example, the title of a valid portion to be displayed next may be displayed three seconds before the reproduction of the valid portion to be displayed next, as illustrated in FIG. 9.

Referring to FIG. 2, the transmission module 270 may transmit a log information list 400 to the service server 11 or to a content reproduction apparatus that has requested the log information list 400, i.e., the content reproduction apparatus 201.

The storage module 260 may store an original content, recommendation information regarding the original content, and the log information list 400. The storage module 260 may be a nonvolatile memory device such as a cache, a read-only memory (ROM), a programmable ROM (PROM), an erasable programmable ROM (EPROM), an electrically erasable programmable ROM (EEPROM), or a flash memory; or a volatile memory device such as a random access memory (RAM). However, the storage module 260 is not restricted to such devices.

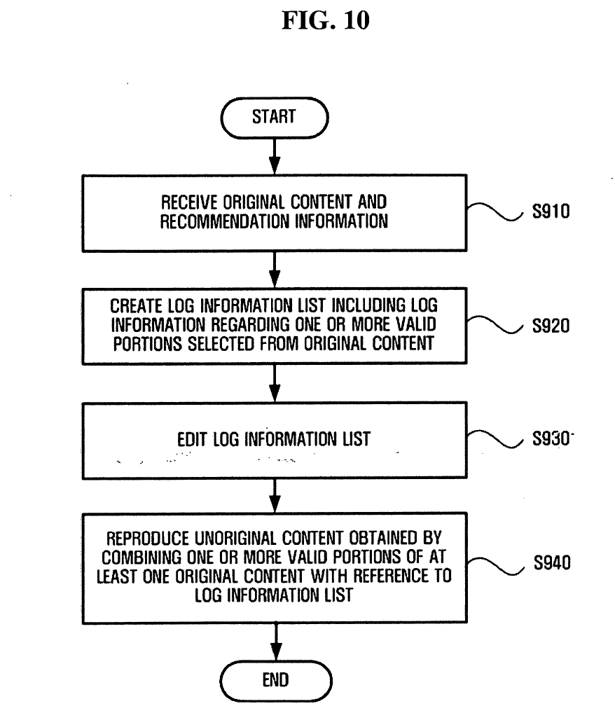

FIG. 10 illustrates a flowchart of a content reproduction method according to an exemplary embodiment of the present invention. Referring to FIG. 10, an original content and recommendation information regarding the original content are received from an external device (S910). Operation S910 may be performed by the reception module 210 of the content reproduction apparatus 200.

Thereafter, a log information list 400 including log information regarding one or more valid portions selected from the original content is created (S920). Operation S920 may include a first process of providing a GUI for selecting one or more valid portions from the original content; a second process of setting a selection frequency threshold for automatically selecting one or more valid portions from the original content; and a third process of storing log information regarding either one or more valid portions selected by a user or one or more valid portions having a frequency of selection higher than the selection frequency threshold in the log information list 400. The first process may be performed by the GUI module 220, and the third process may be performed by the creation module 240.

Once the log information list 400 regarding the original content is created, detailed information regarding each valid portion of the original content is set by appropriately editing the log information list 400 (S930). Operation S930 may include a fourth process of providing a GUI for setting detailed information for each valid portion of the original content; and a fifth process of receiving detailed information regarding each valid portion of the original content. The fourth process may be characterized by displaying a valid portion selected manually by a user from a valid portion selected automatically according to a set of rules and displaying a recommended title for each valid portion of the original content.

Thereafter, an unoriginal content is created by combining one or more of the valid portions of the original content with reference to the log information list 400 (S940). Operation S940 may include determining whether there is at least one second valid portion associated with a first valid portion, which is selected from the valid portions of the original content. If there is no second valid portion associated with the first valid portion, only the first valid portion is reproduced. If there is one or more second valid portions associated with the first valid portion, the first valid portion and the second valid portions are sequentially reproduced.

Thereafter, the log information list 400 may be transmitted to the service server 11 or to another content reproduction apparatus 201 that has requested the log information list 400. If the content reproduction apparatus 201 is already provided with the original content by the content providing server 100, the content reproduction apparatus 201 may be able to create an unoriginal content based on the original content with reference to the log information list 400.

Each element described above may be implemented as a kind of ‘module’. The term ‘module’, as used herein, means, but is not limited to, a software and/or hardware component, such as a Field Programmable Gate-Array (FPGA) or Application-Specific Integrated Circuit (ASIC), which performs certain tasks. A module may be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they are executed using one or more computers in a communication system.

Exemplary embodiments of the present invention can also be implemented through computer readable code/instructions stored on a medium, e.g., a computer readable medium, to control at least one processing element to implement any above described exemplary embodiment. The medium can correspond to any medium/media permitting the storing and/or transmission of the computer readable code.

The computer readable code can be recorded/transferred on a medium in a variety of ways, for example, through the Internet. Examples of the medium include recording media, such as magnetic storage media (e.g., ROM, floppy disks, hard disks, etc.) and optical recording media (e.g., CD-ROMs, or DVDs). In another exemplary embodiment, the medium may include transmission media such as carrier waves, the Internet, a signal, such as a resultant signal or bitstream, and a distributed network, so that the computer readable code is stored/transferred and executed in a distributed fashion. The processing element could include a processor or a computer processor, and processing elements may be distributed and/or included in a single device.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in descriptive sense only and not for purposes of limitation.

What is claimed is:

1. A content reproduction apparatus comprising:
a creation module which creates a log information list including log information regarding one or more valid portions selected from at least one original content; and
a reproduction module which reproduces an unoriginal content with reference to the log information list, the unoriginal content comprising a combination of the one or more selected valid portions.

2. The content reproduction apparatus of claim 1, further comprising a graphic user interface (GUI) module which provides a GUI for selecting the one or more valid portions from the original content during reproduction of the original content,
wherein the GUI comprises at least one of a progress bar indicating a state of the reproduction of the original content, a number of bars indicating a number of times each of the one or more valid portions of the original content has been selected, and a threshold setting bar for setting a selection frequency threshold for automatically selecting the one or more valid portions from the original content.

3. The content reproduction apparatus of claim 2, wherein the creation module automatically adds the log information regarding the one or more valid portions having a frequency of selection higher than the selection frequency threshold to the log information list.

4. The content reproduction apparatus of claim 1, wherein the creation module adds the log information regarding the one or more valid portions selected by a user to the log information list.

5. The content reproduction apparatus of claim 1, further comprising a graphical user interface (GUI) module which provides a GUI for setting detailed information for each of the one or more valid portions of the original content,
wherein the detailed information comprises at least one of a title of each of the one or more valid portions of the original content, reproduction sequence information indicating when to reproduce each of the one or more valid portions of the original content, reproduction frequency information indicating a number of times each of the one or more valid portions of the original content has been reproduced, and association information indicating whether the one or more valid portions of the original content are associated with one another.

6. The content reproduction apparatus of claim 5, wherein the GUI module displays a first valid portion, among the one or more valid portions, which is selected manually by a user differently from a second valid portion, among the one or more valid portions, which is selected automatically according to a set of rules set in advance by the user.

7. The content reproduction apparatus of claim 5, wherein, if a first valid portion, among the one or more valid portions, selected by the user is associated with a second valid portion, among the one or more valid portions, the reproduction module sequentially reproduces the first and second valid portions as the unoriginal content.

8. The content reproduction apparatus of claim 1, wherein the log information comprises at least one of an identifier of the original content, reproduction start information indicating when reproduction of each of the one or more valid portions of the original content will begin and reproduction end information indicating when the reproduction of each of the one or more valid portions of the original content will end.

9. The content reproduction apparatus of claim 1, further comprising a transmission module which transmits the log information list to a service server or to a device that has requested the log information list.

10. The content reproduction apparatus of claim 9, wherein the service server stores and manages the log information list and provides a user interface for providing the log information list to the device that has requested the log information list.

11. A content reproduction method comprising:
creating a log information list including log information regarding one or more valid portions selected from an original content; and
reproducing an unoriginal content with reference to the log information list, the unoriginal content comprising a combination of the one or more selected valid portions.

12. The content reproduction method of claim 11, further comprising providing a GUI for selecting the one or more valid portions from the original content during reproduction of the original content,
wherein the GUI comprises at least one of a progress bar indicating a state of the reproduction of the original content, a number of bars indicating a number of times each of the one or more valid portions of the original content has been selected, and a threshold setting bar for setting a selection frequency threshold for automatically selecting the one or more valid portions from the original content.

13. The content reproduction method of claim 12, wherein the creating comprises automatically adding the log information regarding the one or more valid portions having a frequency of selection higher than the selection frequency threshold to the log information list.

14. The content reproduction method of claim 11, wherein the creating comprises adding the log information regarding the one or more valid portions selected by a user to the log information list.

15. The content reproduction method of claim 11, further comprising providing a graphic user interface (GUI) for setting detailed information for each of the one or more valid portions of the original content,
wherein the detailed information comprises at least one of a title of each of the one or more valid portions of the original content, reproduction sequence information indicating when to reproduce each of the one or more valid portions of the original content, reproduction frequency information indicating a number of times each of the one or more valid portions of the original content has been reproduced, and association information indicating whether the one or more valid portions of the original content are associated with one another.

16. The content reproduction method of claim 15, wherein the providing comprises displaying a first valid portion, among the one or more valid portions, which is selected manually by a user differently from a second valid portion, among the one or more valid portions, which is selected automatically according to a set of rules set in advance by the user.

17. The content reproduction method of claim 15, wherein the reproducing the unoriginal content comprises, if a first valid portion, among the one or more valid portions, selected by the user is associated with a second valid portion, among the one or more valid portions, sequentially reproducing the first and second valid portions as the unoriginal content.

18. The content reproduction method of claim 11, wherein the log information comprises at least one of an identifier of the original content, reproduction start information indicating when reproduction of each of the valid portions of the original content will begin and reproduction end information indicating when the reproduction of each of the one or more valid portions of the original content will end.

19. The content reproduction method of claim 11, further comprising transmitting the log information list to a service server or to a device that has requested the log information list.

20. The content reproduction method of claim 19, wherein the service server stores and manages the log information list and provides a user interface for providing the log information list to the device that has requested the log information list.
